(19) United States
(12) Patent Application Publication
(10) Pub. No.: US 2026/0296669 A1
(43) Pub. Date: Oct. 1, 2026

(54) METHOD FOR ASSISTING WITH PROPULSION BY DETECTING A FAILURE OF A TURBOSHAFT ENGINE OF AN AIRCRAFT

(71) Applicant: SAFRAN HELICOPTER ENGINES, Bordes (FR)

(72) Inventors: Sébastien Alexis Matthieu Carles, Moissy-Cramayel (FR); Jean-Philippe Jacques Marin, Moissy-Cramayel (FR); Sophie Humbert, Moissy-Cramayel (FR)

(73) Assignee: SAFRAN HELICOPTER ENGINES, Bordes (FR)

(21) Appl. No.: 19/100,927

(22) PCT Filed: Aug. 8, 2023
(86) PCT No.: PCT/FR2023/051256

§ 371 Date: Feb. 3, 2025

(30) Foreign Application Priority Data
Aug. 12, 2022 (FR) FR2208297

(51) Int. Cl. B64D 45/00; B64D 27/10; B64D 31/09; F01D 21/00; G05D 1/85; G05D 109/20

(52) U.S. Cl. CPC B64D 45/00; B64D 27/10; B64D 31/09; F01D 21/003; G05D 1/854; B64D 2045/0085; G05D 2109/20

(57) ABSTRACT

This propulsion-assistance method by detecting a failure in a turboshaft engine of an aircraft operating in a nominal mode, the aircraft comprising a deactivated assistance engine, comprises a step of comparing operating parameters of the turboshaft engine with the equivalent parameters of a model representing a healthy turboshaft engine, a step of detecting a failure in the turboshaft engine by detecting an anomaly in at least one operating parameter of the turboshaft engine, a step of selecting an activation mode of the assistance engine according to the operating parameters of the turboshaft engine and/or flight parameters of the aircraft, and a step of activating the assistance engine with the activation mode selected.

### TECHNICAL FIELD

The present invention relates to the assistance of an aircraft turboshaft engine following the detection of a failure in said aircraft.

In particular, the present invention relates to helicopters with twin-engine architecture, one of the two engines of which can operate in a deactivated or energy-saving mode, also referred to as standby mode.

In general terms, the invention applies to all aircraft comprising at least two engines.

### PRIOR ART

A turboshaft engine, and in particular a turboshaft engine of an aircraft, for example a turboshaft engine of a helicopter, must be started before being able to supply thrust power or mechanical power to the rotor. In particular, starting comprises heating of the components of the turboshaft engine as well as rotation of the turbine.

During a flight phase of an aircraft comprising an architecture with two turboshaft engines, one turboshaft engine may sometimes be switched off because of the use of a particular flight mode, for example an energy-saving mode, also referred to as standby mode, the other turboshaft engine operating in nominal mode.

In this standby mode, moreover detailed in the document FR2967132A1, the turboshaft engine remains rotating at low speed while being driven by combustion gases or by an assistance device such as an electric machine. In this standby mode, the combustion chamber may be switched off. In a variant, the combustion chamber is ignited while the turboshaft engine is or is not assisted in its rotation.

To leave this standby mode, in particular in the case of failure of the turboshaft engine operating in nominal mode, it is possible to restart the turboshaft engine by means of a conventional restart or with a rapid restart. The document FR3027058A1 mentions in particular that a normal restart takes place over a period of 10 seconds to 1 minute while a rapid restart takes place over a period of between 5 and 15 seconds.

In order to detect failures or breakdowns in a turboshaft engine with an architecture with two turboshaft engines, it is normal to compare the performances and parameters of the two turboshaft engines or when they are operating in the same way at the same speed.

However, when one of the two turboshaft engines is in a standby mode, it is not possible to detect failures by comparing the two turboshaft engines and the consistency of their performances and of their operating parameters, the rotation speed and the temperature of the turboshaft engine on standby being lower than those of the turboshaft engine in nominal mode.

### DESCRIPTION OF THE INVENTION

The aim of the present invention is therefore to overcome the aforementioned disadvantages and to provide improved detection of failures in a turboshaft engine, as well as better management of the activation of an assistance engine when a failure is detected. The object of the present invention is a propulsion assistance method by detecting a failure in a turboshaft engine of an aircraft operating in nominal mode, the aircraft comprising a deactivated assistance engine. Nominal mode means the normal operating mode where the engine is supplying power. The method comprises a step of comparing operating parameters of the turboshaft engine with equivalent parameters of a model representing a healthy turboshaft engine, a step of detecting a failure in the turboshaft engine by detecting an anomaly in at least one operating parameter of the turboshaft engine, a step of selecting an activation mode of the assistance engine according to the operating parameters of the turboshaft engine and/or flight parameters of the aircraft, and a step of activating the assistance engine with the activation mode selected.

Thus failures on a turboshaft engine are not detected in comparison with another active turboshaft engine but in comparison with an internal model representing a healthy turboshaft engine.

In one embodiment, the flight parameters of the aircraft comprise the flight altitude of the aircraft, the activation mode of the assistance engine being selected according to the possibility of maintaining the flight altitude of the aircraft over the time necessary for activating the assistance engine.

Advantageously, the step of comparing operating parameters of the turboshaft engine with the equivalent parameters of a model representing a healthy turboshaft engine is implemented by a computer of the turboshaft engine storing the model representing a healthy turboshaft engine.

In one embodiment, the step of detecting a failure in the turboshaft engine comprises measuring a significant difference between an operating parameter of the turboshaft engine and the equivalent parameter of the model representing a healthy turboshaft engine.

Advantageously, the activation mode of the assistance engine is selected between a normal activation mode having a first activation duration, an accelerated activation mode having a second activation duration and a rapid activation mode having a third activation duration, the first duration being longer than the second duration and the second duration being longer than the third duration, the normal activation mode being favoured over the accelerated activation mode, the accelerated activation mode also being favoured over the rapid activation mode.

In a particular embodiment, the assistance engine is a second turboshaft engine. Advantageously, the normal activation mode comprises a step of thermal stabilisation at a predefined temperature of the assistance engine and is favoured when no failure of the turboshaft engine is detected and an onboard computer and/or a pilot of the aircraft gives the instruction for this to the assistance engine.

Advantageously, the operating parameters of the turboshaft engine or the detectable failures comprise the fuel flow rate, and/or the temperature and/or the rotation speed at the output of a high-pressure turbine of the turboshaft engine, and/or the output pressure of a compressor of the turboshaft engine, and/or the torque, and/or the extinction of a combustion chamber of the turboshaft engine, and/or a leak on an oil circuit, and/or a leak on a fuel circuit, and/or a detection of chips, and/or an inability to regulate the performances of the turboshaft engine, and/or inconsistency between the power demand and the power supplied, and/or a potential impact on the trajectory of the aircraft.

In one embodiment, the assistance engine is a second turboshaft engine, and the normal activation mode, the accelerated activation mode and the rapid activation mode comprise the assistance of the second turboshaft engine by an electric machine of the aircraft, the normal activation mode comprising a thermal stabilisation at a predefined temperature of the second turboshaft engine and the use of a fuel flow-rate law allowing an activation time of between 1 and 3 minutes, the accelerated activation mode comprising the use of a fuel flow-rate law allowing an activation time of between 10 seconds and 1 minute, and the rapid activation mode comprising the use of a specific starting system configured to use an assistance torque and a fuel flow-rate law allowing a time of activation of the second turboshaft engine between 5 seconds and 15 seconds.

In a particular embodiment, the deactivated assistance engine corresponds to an operating mode of the assistance engine equivalent to a standby mode or to a mode intermediate between a standby mode and a nominal operating mode.

### BRIEF DESCRIPTION OF THE DRAWINGS

Other aims, features and advantages of the invention will become apparent upon reading the following description, given merely as a non-limiting example, and made with reference to the appended drawings, wherein:

FIG. 1 illustrates the steps of the method according to the invention;

FIG. 2 is an outline diagram of the various states of the assistance engine according to the activation mode selected for said assistance engine during the implementation of the method according to the invention.

### DETAILED DISCLOSURE OF AT LEAST ONE EMBODIMENT

In one embodiment, the method according to the invention is implemented in an aircraft, for example a helicopter, comprising a turboshaft engine and an assistance engine that can supply power to a main transmission box of the aircraft.

The assistance engine is for example electric machine or a second turboshaft engine. The present description will be made with reference to a second turboshaft engine, the turboshaft engine previously mentioned being considered to be a first turboshaft engine.

The first and second turboshaft engines each comprise for example a compressor that raises the pressure of a gas at the inlet to the turboshaft engines, a combustion chamber that raises the temperature of the compressed gas, and an expansion turbine that also drives the compressor.

In particular, the first and second turboshaft engines are for example turboshaft engines with a free turbine, the expansion turbine being divided into a high-pressure turbine, also referred to as the turbine of the gas generator, and a power turbine, also referred to as a free turbine.

The method according to the invention is in particular implemented when the aircraft operates with a specific consumption mode such as an energy-saving mode, in particular when one of the two turboshaft engines, for example the first turboshaft engine, operates in a nominal mode, in other words in an operating mode offering standard performances and enabling the aircraft to move in the atmosphere, and when the second turboshaft engine operates in a deactivated mode. In particular, deactivated mode means a standby mode of the second turboshaft engine, or a consumption mode intermediate to the standby mode and to the nominal mode of the second turboshaft engine.

The intermediate consumption mode is for example an operating mode of the second turboshaft engine when the latter changes from its nominal mode to a standby mode, or from its standby mode to its nominal mode.

The standby mode is a consumption mode enabling the second turboshaft engine of the aircraft have a low fuel consumption, while allowing activation that can be rapid, for a situation where the aircraft would need the two turboshaft engines or in the case where the first turboshaft engine would have a failure.

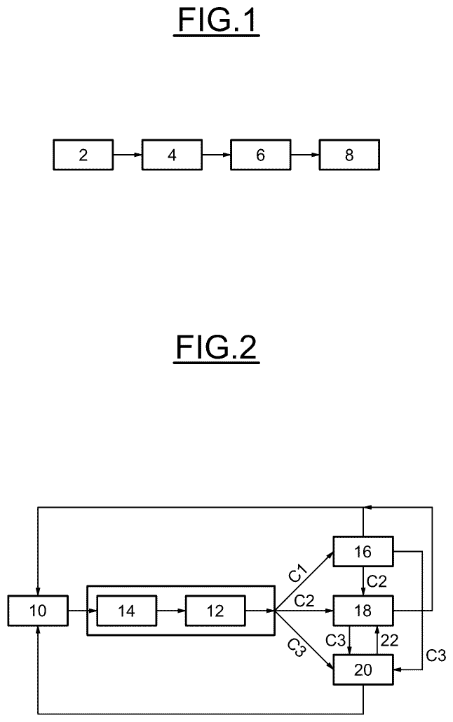

FIG. 1 shows schematically the various steps of the propulsion assistance method by detecting a failure in an aircraft turboshaft engine.

In the implementation of this method, a step 2 of comparing operating parameters of the first turboshaft engine with the equivalent parameters of a model representing a healthy turboshaft engine is first implemented.

The model representing a healthy turboshaft engine is for example stored in a computer of the first turboshaft engine, said computer implementing the step 2 of comparing the operating parameters.

A step 4 of detecting an anomaly in at least one of the operating parameters of the first turboshaft engine is next implemented.

This step 4 of detecting an anomaly comprises for example the measurement of a significant difference between an operating parameter of the first turboshaft engine and the equivalent parameter of the model representing a healthy turboshaft engine. Significant difference means a difference the value of which is predetermined for each operating parameter and symptomatic of a failure in the first turboshaft engine.

In particular, the operating parameters of the first turboshaft engine and more broadly the detectable failures comprise the anomalies relating to the fuel flow rate, and/or the temperature at the output of the high-pressure turbine and/or the rotation speed at the output of a high-pressure turbine of the turboshaft engine, and/or the output pressure of a compressor of the turboshaft engine, and/or the torque, and/or the extinction of a combustion chamber of the turboshaft engine, and/or a leak on an oil circuit, and/or a leak on a fuel circuit, and/or a detection of chips, and/or an inability to regulate the performances of the turboshaft engine, and/or inconsistency between the power demand and the power supplied, and/or a potential impact on the trajectory of the aircraft, for example detected via an anomaly in the rotation speed of the free turbine of the rotor, indicating an overspeed or an underspeed, via a variation in the atmospheric pressure indicating that the aircraft is moving away from or closer to the ground, via a variation in the power demand, or via a variation in the power consumed by the engine.

Next a step 6 is performed, of selecting an activation mode of the second turboshaft engine according to the failure previously detected, and more broadly according to the operating parameters of the first turboshaft engine and/or the flight parameters of the aircraft, and/or the potential impact on the trajectory of the aircraft.

Finally, once the activation mode has been selected, a step 8 of activating the second turboshaft engine according to said activation mode selected is implemented.

FIG. 2 shows schematically an outline diagram of the various states of the second turboshaft engine according to the activation mode selected for the second turboshaft engine.

In particular FIG. 2 shows a nominal consumption mode 10 of the second turboshaft engine, a standby mode 12, and a consumption mode 14 intermediate to the standby mode 12 and to the nominal mode 10. The step 8 of activating the second turboshaft engine according to the activation mode selected is applied to the second turboshaft engine in particular when the latter is in an operating mode such as the standby mode 12 or the intermediate consumption mode 14. In the latter modes, the combustion chamber may be extinguished, while the turbine of the gas generator is weakly rotated, for example by means of an electric machine. In a variant, the combustion chamber is ignited and the turbine of the gas generator comprises or does not comprise rotation assistance.

During step 8, it is possible to implement three different activation modes, the selection between these activation modes being made automatically by the computer of the second turboshaft engine or manually by a pilot of the aircraft.

In particular, the three activation modes can impact the aging of the second turboshaft engine differently.

Among the three possible modes, a step can be implemented of using a normal activation mode 16 having a first duration of the second turboshaft engine in the nominal mode of said second turboshaft engine when the aircraft and/or the first turboshaft engine and/or the pilot satisfies a first condition C1. It is a case of the longest activation mode possible, it makes it possible in particular to preserve the mechanical integrity of the second turboshaft engine.

In one embodiment, the first condition C1 comprises the reception by the second turboshaft engine of an activation instruction sent by an onboard computer and/or by a pilot of the aircraft.

This normal activation mode 16 comprises a step of thermal stabilisation at a predefined temperature of the second turboshaft engine. In a variant, this mode 16 comprises a step of gradual powering up of the second turboshaft engine to an equilibrium of the powers supplied between the first and second turboshaft engines.

The normal activation mode 16 furthermore comprises the use of a fuel flow-rate law and an optimisation of the torque allowing an activation time of between 1 and 3 minutes.

This mode 16 thus makes it possible to gradually change the temperature of the components of the second turboshaft engine.

This normal activation mode 16 is the activation mode most usually used when it is a case of an activation that is often not urgent. It is the mode least impacting the aging of the turboshaft engine and is therefore favoured.

The second possible type of activation is the use of an accelerated activation mode 18 having a second duration of the second turboshaft engine in the nominal mode of said second turboshaft engine, and this when the aircraft and/or the first turboshaft engine satisfies a second condition C2.

The second condition C2 comprises for example the detection of a breakdown on the first and/or second turboshaft engine and/or on the rest of the aircraft, and more broadly an anomaly representing a failure, for example the loss of redundancy of a sensor, an excessive oil temperature, or the loss of an energy source of the aircraft.

In a variant, the second condition C2 comprises the detection of flight conditions requiring operation in nominal mode 10 of the second turboshaft engine. For example, the atmospheric pressure measured is not compatible with the use of a single turboshaft engine in nominal mode, and it is therefore necessary to activate the second turboshaft engine. In a variant, the second condition C2 comprises the reception by the second turboshaft engine of an activation instruction sent by an onboard computer and/or a pilot of the aircraft.

The accelerated activation mode 18 is substantially similar to the normal activation mode 16, but comprises the use of a fuel flow-rate law allowing an activation time of between 10 seconds and one minute. This accelerated activation mode 18 is therefore shorter, in particular by virtue of the absence of a thermal stabilisation step, and makes it possible to activate the second turboshaft engine quickly. This activation nevertheless involves a high impact on the aging of the second turboshaft engine.

The third activation mode is the use of a rapid activation mode 20 having a third duration of the second turboshaft engine in the nominal mode 10 of said second turboshaft engine when the aircraft and/or the first turboshaft engine satisfies a third condition C3.

The third condition C3 also comprises the detection of a breakdown, for example on the first turboshaft engine, or more broadly an anomaly representing a failure causing a loss of power, for example an anomaly among the fuel flow rate values, and/or the temperature and/or the rotation speed at the output of a high-pressure turbine of the first turboshaft engine, and/or the output pressure of a compressor of the turboshaft engine, and/or the torque, and/or the detection of extinction of a combustion chamber of the turboshaft engine, and/or a leak on an oil circuit, and/or a leak on a fuel circuit, and/or a detection of chips, and/or an inability to regulate the performances of the turboshaft engine, and/or inconsistency between the power demand and the power supplied, and/or a potential impact on the trajectory of the aircraft. These anomalies generally necessitate a rapid activation of the second turboshaft engine since they may be symptomatic of a significant loss of power of the first turboshaft engine.

In a variant, the third condition C3 comprises the detection of flight conditions urgently requiring operation in nominal mode 10 of the second turboshaft engine, or comprises the reception by the second turboshaft engine of an activation instruction sent by an onboard computer and/or by a pilot of the aircraft.

The rapid activation mode 20 is different from the previous two activation modes. In particular, the rapid activation mode 20 comprises the use of a specific start-up system configured and sized to use a fuel flow-rate law allowing an activation time of between 5 and 15 seconds, around 10 seconds.

The rapid activation mode 20 does however have a high impact on the aging of the second turboshaft engine and is used only in the case of emergency.

Among the three activation modes, the normal activation mode 16 is favoured over the accelerated activation mode 18, and the accelerated activation mode 18 is also favoured over the rapid activation mode 20. This is because an activation with low impact on aging is favoured, although the first duration is longer than the second duration, and the second duration is longer than the third duration.

Optionally, the second turboshaft engine comprises an electrical assistance machine and each of the normal activation, accelerated activation or rapid activation modes comprises a step of assistance of the second turboshaft engine by the electric assistance machine of the aircraft.

In other words, the electric assistance machine participates in the rotation of the second turboshaft engine when it is activated in order to accelerate said activation.

Advantageously, the flight parameters of the aircraft comprise the flight altitude of the aircraft, and the selection of the activation mode of the assistance engine, in other words of the second turboshaft engine, is made according to the possibility of maintaining the flight altitude of the aircraft over the time necessary for activating the second turboshaft engine.

Thus the first, second and third conditions each comprise an additional condition of maintaining the flight altitude of the aircraft over the time necessary for activating the second turboshaft engine. This is because, although the normal activation mode 16 is favoured since it only slightly impacts the aging of the second turboshaft engine, if this does not make it possible to guarantee maintenance of the flight altitude of the aircraft a more rapid activation mode will be favoured. The same reasoning applies to the accelerated activation mode 18.

In addition, an activation mode may be interrupted in favour of another activation mode when the conditions of the other activation mode are met.

For example, when a normal activation mode 16 is underway but a significant failure is detected, a rapid activation mode 20 is implemented. However, if the specific start-up system has a failure 22, an accelerated activation mode 18 is finally implemented.

In one embodiment, the method is implemented continuously by a computer of the second turboshaft engine as long as the second turboshaft engine is not in its nominal operating mode 10. Thus the steps of comparing the parameters 2 and of detecting failures 4 stop only when the second turboshaft engine is in its nominal operating mode 10.

1. Propulsion-assistance method by detecting a failure in a turboshaft engine of an aircraft operating in a nominal mode, the aircraft comprising a deactivated assistance engine, the method comprising a step of comparing operating parameters of the turboshaft engine with equivalent parameters of a model representing a healthy turboshaft engine, a step of detecting a failure in the turboshaft engine by detecting an anomaly in at least one operating parameter of the turboshaft engine, a step of selecting an activation mode of the assistance engine according to the operating parameters of the turboshaft engine and/or flight parameters of the aircraft, and a step of activating the assistance engine with the activation mode selected.

2. Method according to claim 1, wherein the flight parameters of the aircraft comprise the flight altitude of the aircraft, the activation mode of the assistance engine being selected according to the possibility of maintaining the flight altitude of the aircraft over the time necessary for activating the assistance engine.

3. Method according to claim 1, wherein the step of comparing operating parameters of the turboshaft engine with the equivalent parameters of a model representing a healthy turboshaft engine is implemented by a computer of the turboshaft engine storing the model representing a healthy turboshaft engine.

4. Method according to claim 1, wherein the step of detecting a failure in the turboshaft engine comprises measuring a significant difference between an operating parameter of the turboshaft engine and the equivalent parameter of the model representing a healthy turboshaft engine.

5. Method according to claim 1, wherein the activation mode of the assistance engine is selected between a normal activation mode having a first activation duration, an accelerated activation mode having a second activation duration and a rapid activation mode having a third activation duration, the first activation duration being longer than the second activation duration and the second activation duration being longer than the third activation duration, the normal activation mode being favoured over the accelerated activation mode, the accelerated activation mode also being favoured over the rapid activation mode.

6. Method according to claim 1, wherein the assistance engine is a second turboshaft engine.

7. Method according to claim 1, wherein the normal activation mode comprises a step of thermal stabilisation at a predefined temperature of the assistance engine and is favoured when no failure of the turboshaft engine is detected and an onboard computer and/or a pilot of the aircraft gives the instruction for this to the assistance engine.

8. Method according to claim 1, wherein the operating parameters of the turboshaft engine or the detectable failures comprise the fuel flow rate, and/or the temperature and/or the rotation speed at the output of a high-pressure turbine of the turboshaft engine, and/or the output pressure of a compressor of the turboshaft engine, and/or the torque, and/or the extinction of a combustion chamber of the turboshaft engine, and/or a leak on an oil circuit, and/or a leak on a fuel circuit, and/or a detection of chips, and/or an inability to regulate the performances of the turboshaft engine, and/or inconsistency between the power demand and the power supplied, and/or a potential impact on the trajectory of the aircraft.

9. Method according to claim 5, wherein the assistance engine is a second turboshaft engine, and wherein the normal activation mode, the accelerated activation mode and the rapid activation mode comprise the assistance of the second turboshaft engine by an electric machine of the aircraft, the normal activation mode comprising a thermal stabilisation at a predefined temperature of the second turboshaft engine and the use of a fuel feed-rate law allowing an activation time of between 1 and 3 minutes, the accelerated activation mode comprising the use of a fuel flow-rate law allowing an activation time of between 10 seconds and 1 minute, and the rapid activation mode comprising the use of a specific starting system configured to use an assistance torque and a fuel flow-rate law allowing a time of activation of the second turboshaft engine of between 5 seconds and 15 seconds.

10. Method according to claim 1, wherein the deactivated assistance engine corresponds to an operating mode of the assistance engine equivalent to a standby mode or to a mode intermediate between a standby mode and a nominal operating mode.
